(19) United States
(12) Patent Application Publication
(10) Pub. No.: US 2006/0285141 A1
(43) Pub. Date: Dec. 21, 2006

(54) Printing control device and method thereof

(75) Inventors: So-Hye Kim, Suwon-si (KR); Bong-Gi Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics C. Ltd.

(21) Appl. No.: 11/446,122

(22) Filed: Jun. 5, 2006

(30) Foreign Application Priority Data
Jun. 21, 2005 (KR) 2005-0053306

(51) Int. Cl. G06F 3/12

(52) U.S. Cl. 358/1.13; 358/1.15

(57) ABSTRACT

A printing control device and method are provided. The printing control device comprises an application for receiving a print command with respect to an image, an auxiliary program for providing a user interface for setting a print option on an execution window of the application, and a printer driver for applying the print option set through the user interface to the image for printing and converting the image to a print data comprehensible by a printing device. Accordingly, a user simply sets a print option through the user interface display on the execution window of the application, or directly access a registration information dialog box of the printer driver to set the print option.

### PRIORITY

This application claims the benefit under 35 U.S.C. § 119(a) of Korean Patent Application No. 2005-53306, filed Jun. 21, 2005, in the Korean Intellectual Property Office, the entire contents of which are hereby incorporated by reference.

### BACKGROUND OF THE INVENTION

1. Field of the Invention

The present invention relates to a printing control device and a method thereof. More particularly, the present invention relates to a printing control device and method which sets print options through an execution window of an application or directly opens a registration information dialog box of a printer driver.

2. Description of the Related Art

In order to print a document written by an application through a printing device, such as a printer or multifunction peripheral, a printing control device such as computer has to be equipped with a printer driver. The printer driver controls functions of the printer and is provided by the printer manufacturer.

The printer driver provides a user interface (UI) for setting print options to be applied to a printing document. That is, a user sets various print options to be applied to the printing document through the UI provided from the printer driver. The print options comprise printing range, paper type, printing orientation, resolution, overlay, and watermark. The printer driver applies the print options set by the user to the printing document and thereby converts the printing document into print data comprehensible by the printer. If the print options are not set by the user, the printer driver applies a print option setting according to a default set during installation of the printer driver.

Therefore, in order to apply a print option setting to a document, users have to carry out a cumbersome process of accessing a print dialog box 10 as shown in FIG. 1 on an execution window of an application, clicking a registration information button 11 to access a registration information dialog box (not shown), and then setting the print options item-by-item.

In an attempt to shorten this cumbersome process, the printer driver stores the combinations of currently set print option values with a name given by a user (hereinafter referred to as ‘user setting name’), and if a user selects one of the user setting names through a printer driver UI, converts the print document into print data according to the combination of print option values corresponding to the selected setting and prints the print data. This print option setting function is referred to as ‘quick setting’ or ‘user favorites setting function’.

However, the user favorites setting function still requires a user to carry out a cumbersome process of accessing the print option dialog box on the execution window of the application and then accessing the registration information dialog box of the printer driver.

### SUMMARY OF THE INVENTION

Accordingly, the present invention has been developed to address the above and other problems occurring in the related art. Thus, an aspect of exemplary embodiments of the present invention is to provide a printing control device and method for setting print options in an application execution window or directly accessing a registration information dialog box of a printer driver.

The above aspect is achieved by providing a printing control device comprising an application for receiving a print command with respect to an image, an auxiliary program for providing a user interface for setting a print option on an execution window of the application, and a printer driver for applying the print option set through the user interface to the image for printing and converting the image to print data comprehensible by a printing device.

According to an exemplary implementation, the printer driver is configured to process combinations of print option values set item-by-item and process names indicating the respective combinations, and store the combinations and names to a storage unit.

According to an exemplary implementation, the user interface can display the names stored in the storage unit.

According to an exemplary implementation, each name can represent print options.

According to an exemplary implementation, the auxiliary program can transmit one of the names displayed on the user interface to the printer driver, and the printer driver applies a print option setting corresponding to the name transmitted to the image for printing and converts the image into print data

According to an exemplary implementation, the auxiliary program can process through the user interface a display command with respect to a registration information dialog box for setting the print option.

According to an exemplary implementation, the auxiliary program can transmit the display command to the printer driver, and the printer driver can display the registration information dialog box for setting a print option according to the transmitted display command.

According to an exemplary implementation, the auxiliary program comprises a plug-in program that is executed currently when the application is executed.

According to an exemplary implementation, the user interface comprises a display on a tool bar provided in the execution window of the application.

According to an exemplary implementation, the printing control device further comprises a communication interface for transmitting the converted print data to an external printing device.

The above aspect is also achieved by providing a printing control method comprising processing via an application a print command with respect to an image, and converting via a printer driver the image into a print data comprehensible by a printing device. The printing control method further comprises displaying a user interface for setting a print option on an application execution window, setting the print option, and applying the print option set through the user interface to the image and converting the image into print data comprehensible by the printing device.

According to an exemplary implementation, the printing control method further comprises processing combinations of print option values set item-by-item and processing names indicating the respective combinations, and storing the combinations and the names to a storage unit.

According to an exemplary implementation, the printer control method further comprises displaying at least one name stored in the storage unit via the user interface.

According to an exemplary implementation, the names contain a print option setting.

According to an exemplary implementation, the printing control method further comprises transmitting one of the names displayed on the user interface to the printer driver.

According to an exemplary implementation, wherein converting the image into print data comprises applying a print option setting corresponding to the name transmitted to the image for printing and converting the image into print data.

According to an exemplary implementation, the printing control method further comprises receiving through the user interface a display command with respect to a registration information dialog box option provided by the printer driver for setting the print.

According to an exemplary implementation, the printing control method further comprises transmitting the display command to the printer driver, and displaying the registration information dialog box for setting the print option according to the transmitted display command.

According to an exemplary implementation, the printing control method further comprises displaying the user interface on a tool bar provided in the execution window of the application.

According to an exemplary implementation, the printing control method further comprises transmitting the converted print data to the external printing device and printing the print data.

### BRIEF DESCRIPTION OF THE DRAWINGS

The above and other aspects and exemplary features of the present invention will become more apparent by describing certain exemplary embodiments of the present invention in greater detail with reference to the accompanying drawings, in which:

FIG. 1 is a view illustrating one example of a print option dialog box provided when a print command is input to an application;

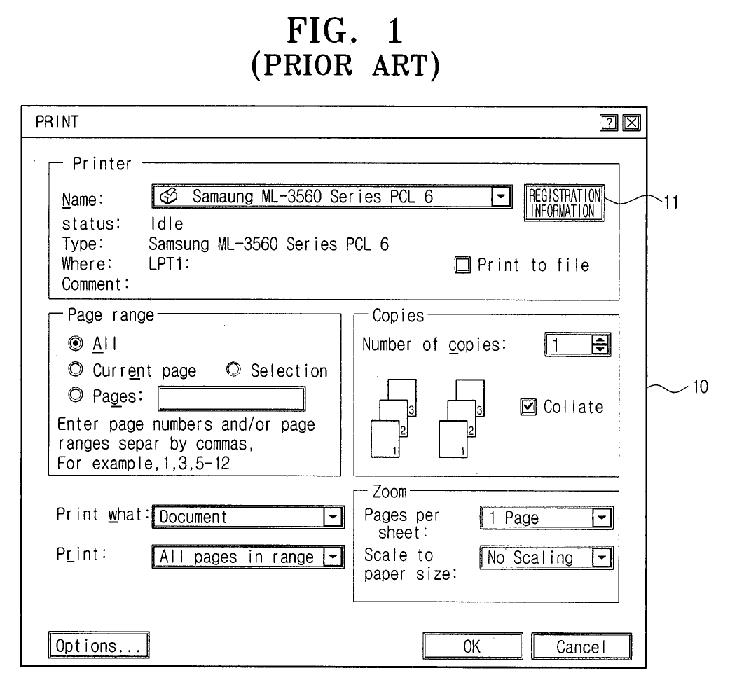

FIG. 2 is a block diagram illustrating one example of a printing control device according to an exemplary embodiment of the present invention;

FIG. 3 is a view illustrating one example of a registration information dialog box provided by a printer driver to set print options according to an exemplary implementation of the present invention;

FIG. 4 is a view illustrating one example of a user interface included and displayed on an application execution window according to an exemplary embodiment of the present invention;

FIG. 5 is a view illustrating one example of a user interface included and displayed on an application execution window according to another exemplary embodiment of the present invention;

FIG. 6 is a flowchart illustrating a printing control method according to a first exemplary embodiment of the present invention; and

FIG. 7 is a flowchart illustrating a printing control method according to a second exemplary embodiment of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

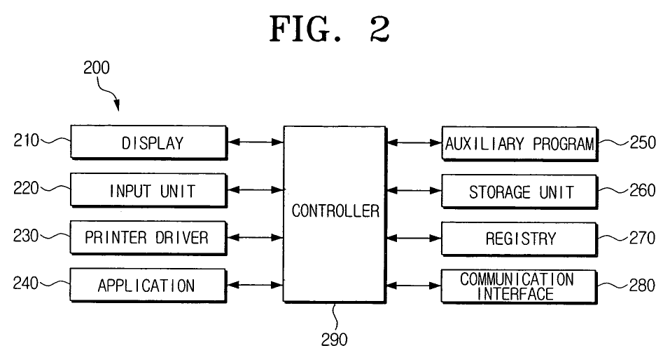

FIG. 2 is a block diagram illustrating one example of a printing control device according to an exemplary embodiment of the present invention.

Referring to FIG. 2, a printing control device 200 according to an exemplary embodiment of the present invention comprises a display 210, an input unit 220, a printer driver 230, an application 240, an auxiliary program 250, a storage unit 260, a registry 270, a communication interface 280, and a controller 290.

The display 210 displays information provided from the printing control device 200 and typically comprises a monitor that can be a cathode ray tube (CRT) or liquid crystal display (LCD).

The input unit 220 comprises a plurality of function keys to set or select various functions supported by the printing control device 200, and may be embodied by a keyboard or mouse.

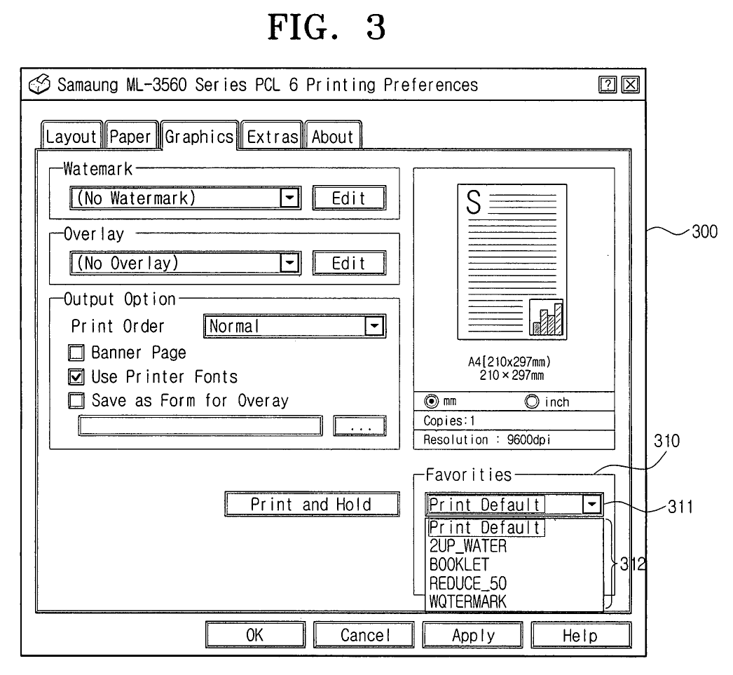

The printer driver 230 applies default or user set print options to an image when a print command is input to the application 240 and converts the image into print data comprehensible by a printing device. The printer driver 230 displays a registration information dialog box 300 (FIG. 3) on the display 210 to allow a user to set the print options.

FIG. 3 is a view illustrating one example of a registration information dialog box provided by a printer driver to set print options according to an exemplary implementation of the present invention.

Referring to FIG. 3, the printer driver unit 230 receives user setting names indicating combinations of currently set print option values through an input window 310, and stores the user setting names with the combinations to the storage unit 260. When a drop down button 311 of the registration information dialog box 300 is selected, the printer driver 230 displays the user setting names 312 stored in the storage unit 260. When one of the user setting names is selected, the printer driver 230 applies combinations of print option values corresponding to the selected user setting name to an input image and converts the input image into print data.

If the printer driver 230 receives a user setting name input through a user interface (not shown) displayed on an execution window of the application 240, the printer driver 230 provides and confirms the combination of print option values corresponding to the input user setting name, and applies the print option values to an input image and converts the image into print data.

The application 240 creates or edits text and image (hereinafter referred to collectively as ‘image’), and receives a print command with respect to the created or edited image. Examples of application 240 comprise word processor programs, data base programs, image editing programs, and web-browsers. Application 240 can comprise any program that can receive a print command with respect to an image. The application 240 displays an execution window (not shown) on the display 210 to allow a user to create or edit an image.

The execution window varies from application to application, but it generally has a document editing area to input or edit an image and a menu area to select various menus provided by the application.

When a request for display of the execution window is input through the input unit 220, the application 240 detects and executes the auxiliary program 250 registered at the registry 270 as a plug-in with respect to the application 240 and thereby displays the user interface (not shown) for setting print options on the menu area of the execution window. Alternatively, the application 240 displays the user interface in the form of tool box. The user interface displayed on the execution window by the auxiliary program 250 will be described in detail hereinbelow.

The auxiliary program 250 is a plug-in that is executed concurrently when the application program 240 is executed, and displays the user interface for setting print options on the execution window of the application 240.

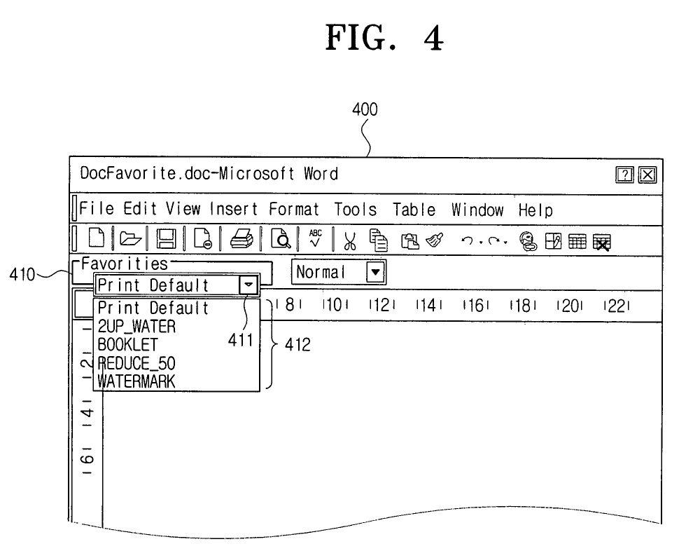

FIG. 4 is a view illustrating one example of the user interface included and displayed on the execution window of the application 240 according to an exemplary embodiment of the present invention.

Referring to FIG. 4, the auxiliary program 250 displays a user interface 410 on an execution window 400 of the application 240 in the form of tool box. The user interface 410 displays the user setting names indicating combinations of the set print option values respectively, and allows a user to select the user setting names. When a drop down button 411 is selected, the auxiliary program 250 displays the user setting names 412 indicating combinations of the set print option values, and when user selects one user setting name, the auxiliary program 250 transmits the selected user setting name to the printer driver 230.

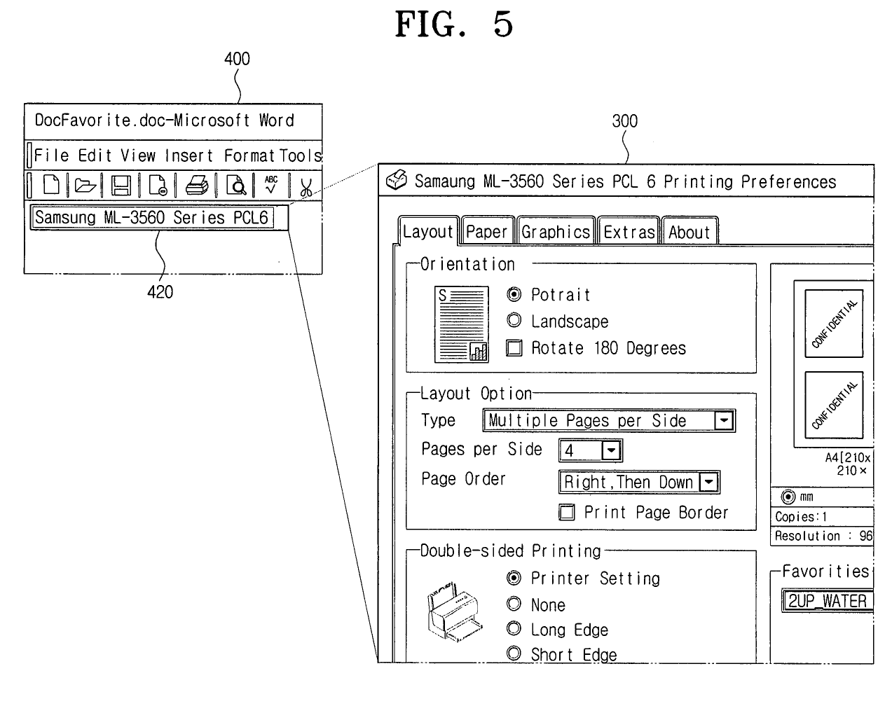

FIG. 5 is a view illustrating one example of a user interface included and displayed on an execution window of the application 240 according to another exemplary embodiment of the present invention.

Referring to FIG. 5, the auxiliary program 250 displays a user interface 420 for directly receiving a display command with respect to the registration information dialog box 300 on the execution window 400. When the user interface 420 is selected, the auxiliary program 250 transmits the display command with respect to the registration information dialog box 300 to the printer driver 230 such that the registration information dialog box 300 is displayed as shown in FIG. 5.

In still another exemplary embodiment, the auxiliary program unit 250 displays on the window 400 both the user interface 410, which displays the user setting names and receives a user setting name, and the user interface 420 which directly receives the display command with respect to the registration information dialog box 300.

The storage unit 260 stores various programs and data required to realize functions of the printing control device 200, and image data which are written by the application 240. Also, the storage unit 260 receives and stores the combinations of currently set print option values and the user setting names indicating the combinations from the printer driver 230.

The registry 270 is maintained and managed by an operating system included in the controller 290 controlling overall operations of the printing control device 200. The registry 200 comprises information required in booting the printing control device 200, such as information about which hardware is installed and which option is set.

According to exemplary embodiments of the present invention, the registry 270 records information indicating that the auxiliary program 250 is registered as a plug-in for the application 240, and thereby executes the auxiliary program 250 concurrently when the application 240 is executed. Although the auxiliary program 250 is independent from the printer driver 230 in these exemplary embodiments, the auxiliary program 250 may be incorporated into the printer driver 230.

The communication interface 280 enables the printing control device 200 to communicate with an external device, and adopts a parallel port, a USB port, and a wireless module. According to exemplary embodiments of the present invention, the communication interface 280 couples to a printing device to transmit the print data converted by the printer driver to the printing device.

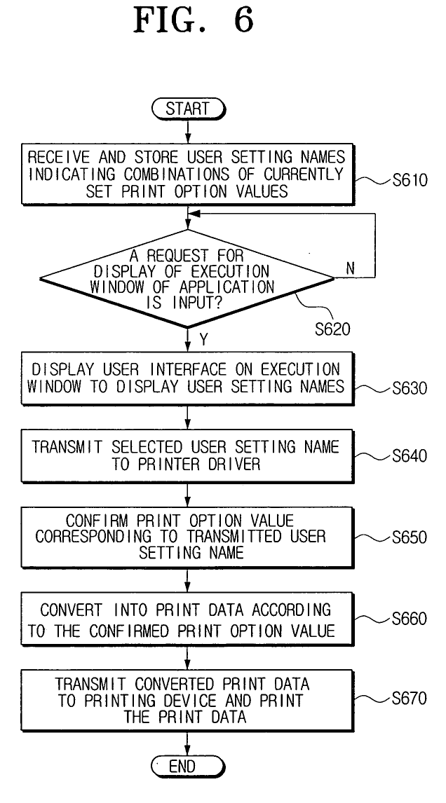

FIG. 6 is a flowchart illustrating a printing control method according to a first exemplary embodiment of the present invention.

Referring to FIG. 6, the printer driver 230 receives user setting names indicating combinations of print option values currently set item-by-item through a ‘user setting menu’ 310 of the registration information dialog box 300, and stores the user setting names to the storage unit 260 at operation S610.

When a request for display of the execution window 400 is input through the input unit 220 at operation 620, the application 240 detects and executes the auxiliary program 250 which is registered as a plug-in with respect to the application 240, and thereby displays the user interface 410 on the menu area of the execution window 400 at operation S630.

If the drop down button 411 of the user interface 410 is selected by a user, the auxiliary program 240 displays the user setting names 412 indicating the combinations of print option values stored in the storage unit 260, and transmits the selected user setting name to the printer driver 230 at operation 640.

The printer driver 230 provides the combination of print option values corresponding to the selected user setting name from the storage unit 260 and confirms the same at operation S650, and applies the print option values to an input image requested for printing and converts the input image into print data at operation S660.

Finally, the controller 290 controls the communication interface 280 to transmit the converted print data to the printing device, and the printing device prints the print data at operation S670.

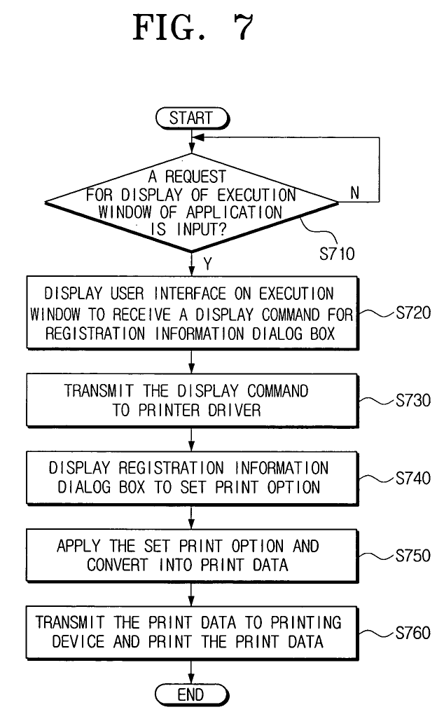

FIG. 7 is a flowchart illustrating a printing control method according to a second exemplary embodiment of the present invention.

Referring to FIG. 7, when a request for display of an execution window is input through the input unit 220 at operation S710, the application 240 detects and executes the auxiliary program 250, which is registered as a plug-in with respect to the application 240 within the registry 270, and displays the user interface 420 on the execution window 400 at operation S720. Through the user interface 420, a display command with respect to the registration information dialog box 300 of the printer driver 230 is directly input.

When the user interface 420 is selected and the display command is input, the auxiliary program 250 transmits the display command with respect to the registration information dialog box 300 to the printer driver 230 at operation S730.

The printer driver 230 displays the registration information dialog box 300 on the display unit 220 at operation S740, receives print option settings and converts an input image requested for printing into print data according to the print option settings at operation S750.

Finally, the controller 290 controls the communication interface 280 to transmit the converted print data to the printing device such that the printing device prints the print data at operation S760.

According to exemplary implementations of the present invention as described above, since the user interface 410 is provided in the execution window of the application 240 to allow a user to directly select a combination of print option values which were previously set, the user can apply a desired print option setting to the input image without accessing the registration information dialog box 300 provided from the printer driver.

Also, it is possible for the user to access the registration information dialog box 300 of the printer driver 230 for setting the print options without carrying out a cumbersome process.

While the present invention has been particularly shown and described with reference to certain exemplary embodiments thereof, it will be understood by those of ordinary skill in the art that various changes in form and detail may be made therein without departing from the spirit and scope of the present invention as defined by the appended claims and equivalents thereof.

What is claimed is:

1. A printing control device comprising:
an application for receiving a print command for an image;
an auxiliary program for providing a user interface for setting a print option on an execution window of the application; and
a printer driver for applying the print option set through the user interface to the image for printing and converting the image to print data for a printing device.

2. The printing control device as claimed in claim 1, wherein the printer driver is configured to receives at least one combination of print option values set item-by-item and at least one name indicative of the combination, and stores the at least one combination and the at least one name to a storage unit.

3. The printing control device as claimed in claim 2, wherein the user interface is configured to display the at least one stored name.

4. The printing control device as claimed in claim 3, wherein the at least one name comprises a print option.

5. The printing control device as claimed in claim 4, wherein the auxiliary program is configured to transmit at least one name displayed on the user interface to the printer driver, and the printer driver applies a print option setting corresponding to the at least one name to the image for printing and converts the image into the print data.

6. The printing control device as claimed in claim 1, wherein the auxiliary program is configured to receive through the user interface a display command with respect to a registration information dialog box provided from the printer driver for setting the print option.

7. The printing control device as claimed in claim 6, wherein the auxiliary program is configured to transmit the display command to the printer driver, and the printer driver displays the registration information dialog box for setting a print option according to the transmitted display command.

8. The printing control device as claimed in claim 1, wherein the auxiliary program comprises a plug-in program executable currently with the application.

9. The printing control device as claimed in claim 1, wherein the user interface comprises a display on a tool bar provided in the execution window of the application.

10. The printing control device as claimed in claim 1, further comprising a communication interface for transmitting the converted print data to an external printing device.

11. A printing control method comprising:
receiving a print command for an image;
converting the image into a print data for a printing device;
displaying a user interface for setting a print option on an application execution window;
applying the print option set through the user interface to the image; and
converting the image into the print data.

12. The printing control method as claimed in claim 11, further comprising:
receiving at least one combination of print option values set item-by-item;
receiving names indicative of the at least one combination; and
storing the at least one combination and the at least one name to a storage unit.

13. The printing control method as claimed in claim 12, further comprising:
displaying at least one name stored in the storage unit via the user interface.

14. The printing control method as claimed in claim 13, wherein the at least one name comprises a print option setting.

15. The printing control method as claimed in claim 14, further comprising:
transmitting at least one name displayed on the user interface to the printer driver.

16. The printing control method as claimed in claim 14, wherein converting the image into print data comprises applying a print option setting corresponding to the at least one name to the image for printing and converting the image into the print data.

17. The printing control method as claimed in claim 12, further comprising:
receiving through the user interface a display command with respect to a registration information dialog box option provided by the printer driver for setting the print.

18. The printing control method as claimed in claim 17, further comprising:
transmitting the display command to the printer driver, and
displaying the registration information dialog box for setting the print option according to the transmitted display command.

19. The printing control method as claimed in claim 12, further comprising:
displaying the user interface on a tool bar provided in the application execution window.

20. The printing control method as claimed in claim 12, further comprising:
transmitting the converted print data to the external printing device and printing the print data.
